(19) United States
(12) Patent Application Publication
(10) Pub. No.: US 2024/0029461 A1
(43) Pub. Date: Jan. 25, 2024

(54) ELECTRONIC DEVICE FOR PROCESSING HANDWRITING INPUT ON BASIS OF LEARNING, OPERATION METHOD THEREOF, AND STORAGE MEDIUM

(71) Applicant: SAMSUNG ELECTRONICS CO., LTD., Suwon-si (KR)

(72) Inventors: Jeongwan Park, Suwon-si (KR); Jihoon Kim, Suwon-si (KR); Donghyuk Lee, Suwon-si (KR)

(21) Appl. No.: 18/373,874

(22) Filed: Sep. 27, 2023

Related U.S. Application Data
(63) Continuation of application No. PCT/KR2022/002236, filed on Feb. 15, 2022.

(30) Foreign Application Priority Data
Mar. 31, 2021 (KR) 10-2021-0042212

(51) Int. Cl. G06V 30/32; G06V 30/22; G06V 30/148; G06V 30/19

(52) U.S. Cl. CPC G06V 30/347; G06V 30/22; G06V 30/148; G06V 30/19147

(57) ABSTRACT

According to various embodiments, an electronic device may comprise a display, a memory for storing a machine learning algorithm related to character separation, and at least one processor, wherein the at least one processor is configured to receive a handwriting input via the display; extract feature information between a series of consecutive strokes corresponding to the handwriting input; merge or separate the strokes through the machine learning algorithm on the basis of the extracted feature information; and perform handwriting recognition on the basis of the result of the merging or separation. Various other embodiments may be provided.

### CROSS-REFERENCE TO RELATED APPLICATIONS

This application is a continuation application, claiming priority under § 365(c), of International Application No. PCT/KR2022/002236 filed on Feb. 15, 2022, which is based on and claims the benefit of Korean patent application number 10-2021-0042212 filed on Mar. 31, 2021, in the Korean Intellectual Property Office, the disclosures of which are incorporated by reference herein in their entireties.

### TECHNICAL FIELD

Various embodiments of the disclosure relate to an electronic device for processing a learning-based handwriting input, a method for operating the same, and a storage medium.

### BACKGROUND ART

Electronic devices are being developed to be able to receive various inputs from the user through a specified input device (e.g., a stylus pen) connected with the electronic device via wireless communication. An electronic device may identify a designated position on an electronic device with a pen input device (which may be referred to herein as a stylus pen for ease of description) and perform its corresponding function.

Input using a stylus pen enables more accurate touch input than using a finger and may be useful for executing memo or sketch applications. Further, handwriting input using a finger as well as a stylus pen provides a higher degree of freedom in creating content, rapid entry, and diversified uses due to enhanced character recognition technology.

### DISCLOSURE OF INVENTION

### Technical Problem

Due to the nature of electronic devices such as smartphones, user handwriting may have a lot of errors because of the size and surface characteristics or the user's situation. Moreover, in watch-type wearable electronic devices which have a very small input window as compared with smartphones, overlaps in handwriting are frequent in the small input window. Further, handwritten characters entered by the user's finger or stylus pen may be illegible due to different sizes, spacing, or slant, and errors may occur due to unbalanced strokes and non-uniformity of words or characters within a sentence. Severely overlapping handwriting that may occur as the user rushes takes much time to recognize and may be hard to perceive in real-time due to deteriorated recognition accuracy.

Various embodiments of the disclosure provide an electronic device for processing a learning-based handwriting input, a method for operating the same, and a storage medium.

### Technical Solution

According to various embodiments, an electronic device may comprise a display, at least one processor, memory storing instructions configured to, when executed, enable the electronic device to receive a handwriting input including overwritten characters through the display, extract feature information from the handwriting input, merge or separate a series of consecutive strokes of the handwriting input based on the extracted feature information, and perform handwriting recognition based on a result of performing the merging or separating.

According to various embodiments, a method for processing a handwriting input based on learning in an electronic device may comprise receiving a handwriting input including overwritten characters through a display of the electronic device, extracting feature information from the handwriting input, merging or separating a series of consecutive strokes of the handwriting input based on the extracted feature information, and performing handwriting recognition based on a result of performing the merging or separating.

According to various embodiments, in a storage medium storing instructions, the instructions configured to be executed by at least one processor to enable the at least one processor to perform at least one operation, the at least one operation may comprise receiving a handwriting input including overwritten characters through a display of an electronic device, extracting feature information from the handwriting input, merging or separating a series of consecutive strokes of the handwriting input based on the extracted feature information, and perform handwriting recognition based on a result of performing the merging or separating.

### Advantageous Effects

According to various embodiments, it is possible to recognize handwriting fast and precisely regardless of the degree of overlapping of handwriting when the user enters handwriting.

According to various embodiments, it is possible to enhance recognition speed and efficiently use memory resources by performing handwriting recognition after extracting, merging, or separating feature information between consecutive strokes in handwriting.

According to various embodiments, it is possible to provide a fast handwriting recognition speed and enhanced recognition result by learning (e.g., training) an algorithm for merging or separating consecutive strokes corresponding to handwriting input even when handwriting inputs overlap.

Effects of the disclosure are not limited to the foregoing, and other unmentioned effects would be apparent to one of ordinary skill in the art from the following description.

### BRIEF DESCRIPTION OF DRAWINGS

FIG. 1 is a view illustrating an electronic device in a network environment according to various embodiments;

FIG. 2A is a perspective view illustrating an electronic device with a digital pen according to an embodiment;

FIG. 2B is a view illustrating an example watch-type wearable electronic device according to various embodiments;

FIG. 3 is a block diagram illustrating an internal configuration of an electronic device according to various embodiments;

FIG. 4 is a view illustrating a machine learning model function for processing strokes in a handwriting recognition process according to various embodiments;

FIG. 5 is a view illustrating various handwriting methods according to various embodiments;

FIGS. 6A and 6B are views illustrating comparison between a rule-based method and a machine learning-based method according to various embodiments;

FIG. 7 is a flowchart illustrating operations of an electronic device according to various embodiments;

FIG. 8 is a view illustrating a machine learning process according to various embodiments;

FIG. 9 is a view illustrating an example of an operation of merging or separating consecutive strokes according to various embodiments;

FIG. 10 is a view illustrating an example of stroke-related feature extraction according to various embodiments;

FIG. 11 is a view illustrating an example of a learning sample for various letter areas according to various embodiments;

FIGS. 12A and 12B are views illustrating examples of a machine learning algorithm according to various embodiments; and

FIG. 13 is a view illustrating an example handwriting input screen in an electronic device according to various embodiments.

The same or similar reference denotations may be used to refer to the same or similar elements throughout the specification and the drawings.

### MODE FOR CARRYING OUT THE INVENTION

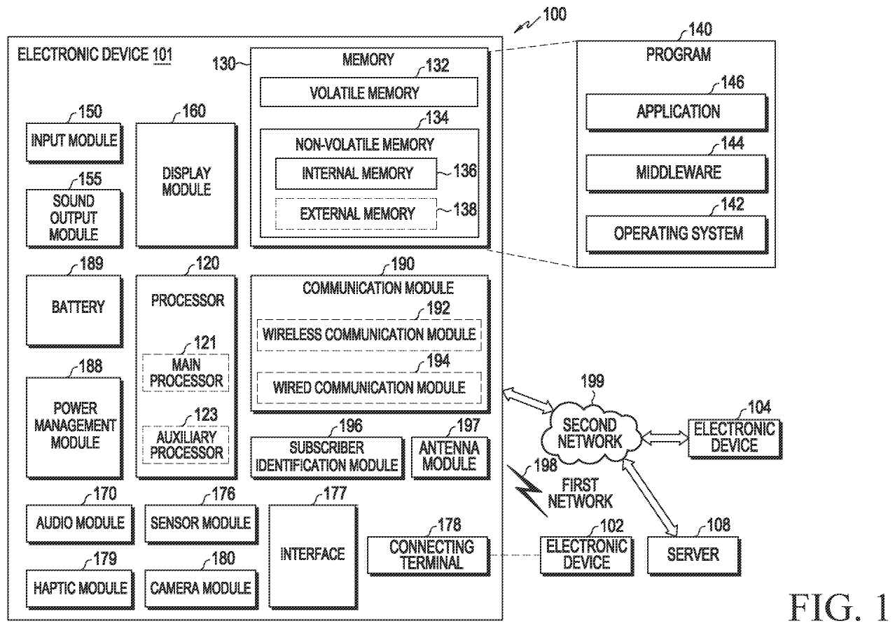

FIG. 1 is a block diagram illustrating an electronic device 101 in a network environment 100 according to various embodiments. Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal According to an embodiment, the display module 160 may include a first display module 351 corresponding to the user's left eye and/or a second display module 353 corresponding to the user's right eye., a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductive body or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

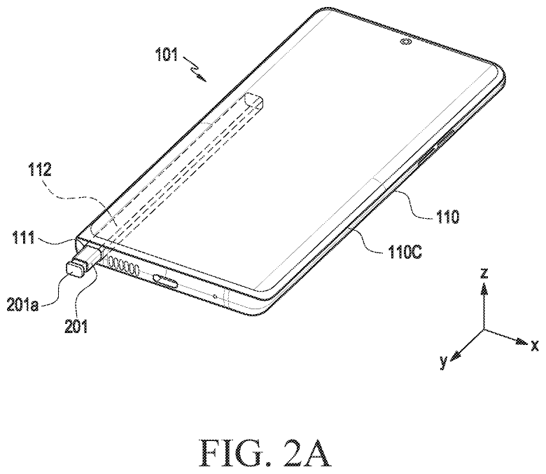

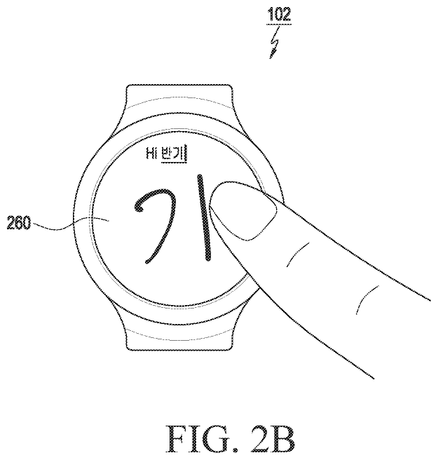

FIG. 2A is a perspective view illustrating an electronic device with a digital pen according to an embodiment.

Referring to FIG. 2A, according to an embodiment, the electronic device 101 may include the components shown in FIG. 1 and may have a structure for inserting the digital pen 201 (e.g., a stylus pen). The electronic device 101 may include a housing 110 and have a hole 111 in a portion, e.g., a side portion, of the housing. The electronic device 101 may include a receiving space 112 connected with the hole 111, and the digital pen 201 may be inserted into the receiving space 112. In the embodiment shown, the digital pen 201 may have a pressable button 201a at an end to be easily pulled out of the receiving space 112 of the electronic device 101. When the button 201a is pressed, a repulsive mechanism (e.g., at least one spring) configured in association with the button 201a may be operated to allow the digital pen 201 to be removed from the receiving space 112.

FIG. 2A illustrates a structure in which the digital pen 201 (e.g., a stylus pen) may be inserted into the electronic device 101. However, according to an embodiment, the digital pen 201 may be attached to or detached from the surface of the electronic device 101. In this case, the housing of the electronic device 101 may include an area to which the stylus pen 201 may be attached. According to another embodiment, the stylus pen 201 may be configured and used separately without being inserted or attached to the electronic device 101. The electronic device 101 may not include a structure into which the stylus pen 201 may be inserted.

FIG. 2B is a view illustrating an example watch-type wearable electronic device according to various embodiments.

FIG. 2B illustrates a watch-type wearable electronic device 102 as an example of a handwriting-capable electronic device. Here, the electronic device 102 of FIG. 2B may be an external electronic device (e.g., the electronic device 102) directly or wirelessly connected with the electronic device 101 of FIG. 1.

As shown in FIG. 2B, the display 260 of the watch-type wearable electronic device 102 may display a user interface when an application for handwriting input is executed. The user may perform handwriting input through an input window of the display 260 using her finger. The user may input letters one by one to the small input window, but overwritten letters may be input due to the size of the input window. Thus, the watch-type wearable electronic device 102 may support an overwrite mode that may separately recognize the overwritten letters.

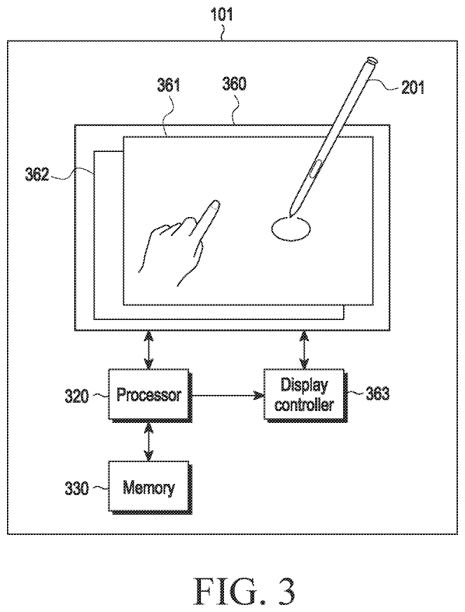

FIG. 3 is a block diagram illustrating an internal configuration of an electronic device according to various embodiments. The electronic device 101 of FIG. 3 may include components identical or similar to those of the electronic device 101 of FIG. 1. In the following, the electronic device 101 may be understood as denoting the electronic device 101 of FIG. 1 such as a smartphone or as denoting the watch-type wearable electronic device 102 of FIG. 2B.

Referring to FIG. 3, a display 360 (e.g., the display module 160 of FIG. 1) for detecting an input by a stylus pen 201 or an input by the user's body (e.g., a finger) may be provided to the electronic device 101 (e.g., the electronic device of FIG. 1).

According to various embodiments, the display 360 may simultaneously support input/output functions of data and may detect touches.

According to an embodiment, the display 360 may receive a handwriting input made by the user through a finger or a stylus pen, and display the handwriting input. The handwriting input may be constituted of at least one stroke, and each stroke may be data constituted of a plurality of points generated by the user input of touching down, dragging, and touching up the display 360 using the user's finger or stylus pen. For example, the number ‘1’ may be written by a single stroke, and the number ‘4’ may be written by two strokes.

According to various embodiments, the display 360 may include a sensing panel 361, a display panel 362, and/or the display controller 363. Although it is described in connection with FIG. 3 that the sensing panel 361 is included in the display 360, it may operate as an input panel different from the display 360 by forming a layer structure with the display panel 362. According to an embodiment, the display 360 may be referred to as a touchscreen.

The sensing panel 361 may detect the position of a touch input of a finger or a stylus pen 201, and the display panel 362 may output an image. The display controller 363 may be a driving circuit that controls the display panel 362 to output an image through the display panel 362.

When the stylus pen 201 supports the electro-magnetic resonance (EMR) type, the sensing panel 361 may be configured as an input pad in an EMR type using electromagnetic sensor or electro-magnetic interface (EMI) type, but this is merely an example. The sensing panel 361 may also be configured as an electrically coupled resonance (ECR)-type input pad.

The sensing panel 361 may receive a magnetic field from the stylus pen 201 and detect the position of the stylus pen 201 therefrom. The sensing panel 361 may include one or more panels forming a mutually layered structure to detect an input by a plurality of sensors.

Further, the sensing panel 361 may be implemented as a touchscreen panel (TSP), and if implemented as a touchscreen panel, identify the position of the stylus pen 201 or the position of the touch made by the finger based on the output signal from the electrode. The stylus pen 201 may be implemented in an active electrostatic (AES) scheme, and it will be easily appreciated by one of ordinary skill in the art that it is not limited to a specific kind of implementation.

Further, the sensing panel 361 may detect contact or approach of the user's finger or the stylus pen 201. For example, the sensing panel 361 may detect a hovering input by the stylus pen 201. The sensing panel 361 may generate an input signal corresponding to the hovering input and transfer it to the processor 320. The sensing panel 361 may generate an input signal including information about the hovering input based on the position where the hovering input is generated, and the manipulation state of the stylus pen 201 or a button provided on the stylus pen 201.

The hardware implemented as a touchscreen panel or in an EMR type capable of sensing the signal from the stylus pen 201 may be referred to as a sensing panel 361. The sensing panel 361 may detect a touch input by a human body or an input by the stylus pen 201. The configuration of the module 360 illustrated in FIG. 3 is merely an example, and the type and number of panels constituting the display 360 and the positions of upper and lower layers of the panel vary depending on the manufacturing technology of the electronic device 101.

The memory 330 may store a program (or application, algorithm, or processing loop) for calculating information (e.g., coordinate information and/or displacement information) about the position of the input means, such as a finger or the stylus pen 201 from the data obtained by the sensing panel 361.

According to various embodiments, the memory 330 may store a machine learning algorithm associated with the strokes corresponding to the handwriting input. The machine learning algorithm is provided to the electronic device 101 during manufacturing, and may be updated through learning after manufacturing.

According to an embodiment, the machine learning algorithm is an algorithm related to character separation, and may be trained to perform character separation on not only overwritten characters but also characters of normal sentences. According to an embodiment, the machine learning algorithm related to the character separation may be trained using samples of overwritten characters and normal sentence samples to perform character separation on overwritten characters or characters written in normal sentences.

According to an embodiment, the machine learning algorithm is an algorithm for merging or separating strokes and may use at least one of a multi-layer-perceptron (MLP), a support vector machine (SVM), or deep learning for training to merge strokes related to the same character and separate strokes related to different characters, but is not limited thereto. Further, the machine learning algorithm may be trained based on a 2-class supervised learning method that extracts a numerical value indicating merging on a stroke with a likelihood of the same character and extracts a numerical value indicating separation on a stroke with a likelihood of different characters. For example, according to supervised learning, ‘1’ may be output for merged strokes, and ‘0’ may be output for separated strokes.

According to various embodiments, the processor 320 may obtain handwriting data corresponding to the handwriting input displayed on the display 360, extract feature information between a designated number of strokes from the obtained handwriting data, perform merging or separation on the strokes based on the extracted feature information, and provide a result of providing the merging or separation to a handwriting recognition engine (or handwriting recognition algorithm). The processor 320 may perform handwriting recognition based on the result of performing the merging or separation. For example, the processor 320 may recognize letters drawn by the user using the handwriting recognition engine on the merged or separated result. For example, the processor 320 may identify and interpret merged or separated strokes constituting the handwriting data drawn by the user to recognize the written characters.

According to various embodiments, the processor 320 may implement the operation of extracting the feature information between the strokes and performing merging and separation through the machine learning engine. According to an embodiment, the processor 320 may be configured to train the machine learning model based on the strokes for grouping the strokes that are likely to be one character. According to an embodiment, the processor 320 may drive and control the machine learning engine to extract features for strokes and merge or separate the strokes based on the extracted features. Here, the machine learning engine may be implemented as a hardware and/or software component in the electronic device 101. As an example, the machine learning engine may be implemented as a program stored in the memory 330. In this case, the machine learning engine may be implemented as instructions stored in the memory 330, and when the instruction is executed by the processor 320, the processor 320 may perform the function corresponding to the instruction.

According to various embodiments, an electronic device 101 may comprise a display 360, at least one processor 320, memory 330 storing instructions configured to, when executed, enable the electronic device to receive a handwriting input including overwritten characters through the display 360, extract feature information from the handwriting input, merge or separate a series of consecutive strokes of the handwriting input based on the extracted feature information, and perform handwriting recognition based on a result of performing the merging or separating.

According to various embodiments, the instructions are configured to enable the electronic device to extract feature information between a predesignated number of strokes among the series of consecutive strokes.

According to various embodiments, the feature information between the strokes may include at least one of a straightness of stroke, a slope angle, position information about a start point of stroke, a slope angle of a virtual ligature (or line between points), or a length ratio of the virtual ligature.

According to various embodiments, the instructions are configured to enable the electronic device to merge or separate the series of consecutive strokes of the handwriting input based on the feature information, using a machine learning algorithm related to character separation, the machine learning algorithm may be trained to perform the character separation on overwritten characters or characters of a normal sentence.

According to various embodiments, the instructions are configured to enable the electronic device to use samples of overwritten characters and normal sentence samples to perform character separation on overwritten characters or characters written in normal sentences. According to various embodiments, the instructions are configured to enable the electronic device to use at least one of a multi-layer-perceptron (MLP), a support vector machine (SVM), or deep learning for training for the machine learning algorithm.

According to various embodiments, the instructions are configured to enable the electronic device to display a handwriting recognition result corresponding to the handwriting input on the display based on a result of performing the merging or separation through a handwriting recognition engine.

According to various embodiments, the instructions are configured to enable the electronic device to display the handwriting input on a first portion of the display and convert a handwriting recognition result corresponding to the handwriting input into text and display the text on a second portion of the display.

According to various embodiments, the instructions are configured to enable the electronic device to perform pre-processing on the received handwriting input and extract feature information between a series of consecutive strokes corresponding to the pre-processed handwriting input.

According to various embodiments, the instructions are configured to enable the electronic device to train the machine learning algorithm related to the character separation based on a 2-class supervised learning method that extracts a numerical value indicating merging on a stroke with a likelihood of the same character and extracts a numerical value indicating separation on a stroke with a likelihood of different characters. According to various embodiments, the instructions are configured to enable the electronic device to identify straightness and slope angle using a first point and a last point of each of the strokes constituting the handwriting input and extract the feature information including the straightness and the slope angle. According to various embodiments, the instructions are configured to enable the electronic device to identify position information about a start point of each stroke based on a first and a last points of each stroke and extract the feature information including the position information. According to various embodiments, the instructions are configured to enable the electronic device to identify a feature of a virtual ligature between a last point of strokes and extract the feature information including position information about each stroke based on a first and last points of each stroke and extract the feature information including a slope angle of the virtual ligature and a length ratio of the virtual ligature

FIG. 4 is a view illustrating various handwriting methods according to various embodiments.

Referring to FIG. 4, when an electronic device, such as a smartphone or tablet PC, is used for handwriting recognition, the user may write according to the input window, so that the handwriting input may be displayed as it is in the general sentence 410.

On the other hand, when using an electronic device that does not have a sufficiently large input window, like a watch-type wearable electronic device, the user may write characters one by one or overwrite characters in the small input window. For example, when the user overwrites characters of a sentence and/or word in the small input window in the case of overwriting 420 in the watch-type wearable electronic device, the result of handwriting recognition may be output by merging strokes through a rule-based method and inputting them to the handwriting recognition engine so as to recognize the overwritten characters. However, in the rule-based method, as the number of strokes according to overwritten handwriting input increases, the recognition may slow down, and more errors may occur in the recognition result.

Therefore, it is required to consider a method for providing the handwriting recognition result in real-time quickly and precisely regardless of an increase in the number of strokes by quickly grouping and separating input strokes through a learning-based merging and separating method when extracting characters from the overwritten handwriting made by the user.

In the following description, the machine learning algorithm, as a method for quickly merging or separating strokes corresponding to handwriting input, may use at least one of a multi-layer-perceptron (MLP), a support vector machine (SVM), or deep learning for training to merge or separate strokes, but is not limited thereto.

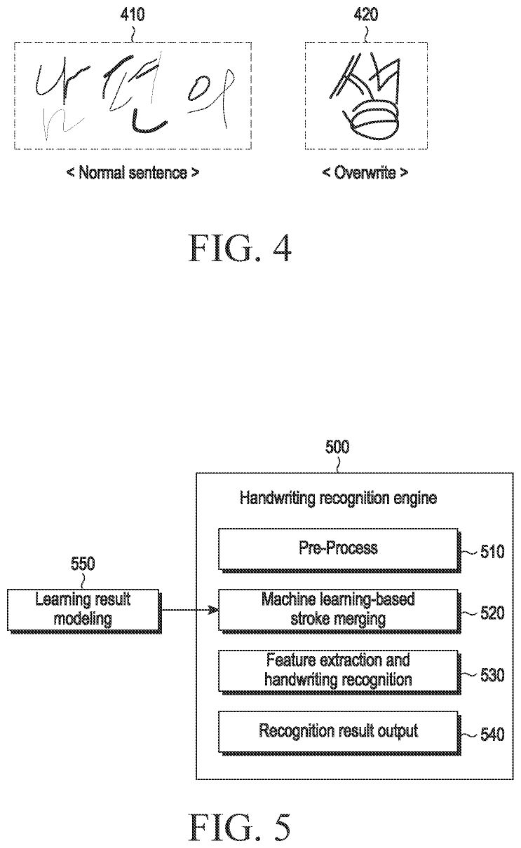

FIG. 5 is a view illustrating a machine learning model function for processing strokes in a handwriting recognition process according to various embodiments.

Referring to FIG. 5, according to various embodiments, operations in the handwriting recognition engine 500 for recognizing handwriting by classifying strokes corresponding to a handwriting input may largely include a pre-processing operation 510, a machine learning-based stroke merging operation 520, a feature extraction and handwriting recognition operation 530, and/or a recognition result output operation 540. According to an embodiment, each operation in the handwriting recognition engine 500 may be implemented as a hardware and/or software component such as a module, and for convenience of description below, the subject of the operation may be referred to as a module.

According to various embodiments, the pre-processing module 510 may perform pre-processing for recognizing a handwriting input. For example, the pre-processing module 510 may remove a noise point from the handwriting input, perform line segmentation, and perform skew correction.

According to various embodiments, the machine learning-based stroke merging module 520 may extract N consecutive strokes among the strokes corresponding to the pre-processed handwriting input, and then may extract features between the strokes. According to an embodiment, the features between the strokes may include at least one of a straightness of stroke, a slope angle, position information about a start point of stroke, a slope angle of a virtual ligature, or a length ratio of the virtual ligature.

According to various embodiments, the machine learning-based stroke merging module 520 may extract N consecutive strokes to extract features for character merging and/or separation between the extracted strokes. For example, the machine learning-based stroke merging module 520 may be trained to allow the extracted features to have numerical values corresponding to the merging or separation based on the extracted features using a 2-class supervised learning method. For example, it may be trained such that when the corresponding feature is merging, the feature is ‘0’ and, when the feature is separation, the feature is ‘1’. As described above, the machine learning algorithm trained using learning data (or training data) may be referred to as learning modeling.

According to various embodiments, when the machine learning-based stroke merging module 520 performs stroke merging, the learning result modeling 550 may be reflected. For example, the machine learning-based stroke merging module 520 may reflect the learned weights when representing the features between the strokes corresponding to the handwriting input as numerical values. For example, as the amount of training data used for learning increases, i.e., as learning progresses, the accuracy of the learning result for merging or separating strokes in the machine learning-based stroke merging module 520 may increase and the processing speed may increase. For example, as the amount of training data used for learning increases, that is, as learning progresses, the accuracy of learning results for merging or separating strokes in the machine learning-based stroke merging module 520 increases. Processing speed may also be faster.

As shown in FIG. 5, according to various embodiments, before the handwriting recognition engine 500 performs handwriting recognition, the machine learning-based stroke merging module 520 may provide the feature extraction and handwriting recognition module 530 with data for bundled strokes obtained by extracting feature information between the consecutive strokes and performing merging or separation.

According to various embodiments, as compared with the method for directly interlocking the strokes pre-processed in the normal overwrite recognition mode to the handwriting recognition engine 500 or interworking grouped strokes to the handwriting recognition engine 500 through a rule-based algorithm, use of the bundled strokes classified by the machine learning-based stroke merging module 520 in handwriting recognition may lead to enhancement in recognition speed in the handwriting recognition engine 500 and reduction in the number of recognition candidates.

According to various embodiments, the feature extraction and handwriting recognition module 530 may extract features and a candidate path for strokes (or bundled strokes) merged by the machine learning-based stroke merging module 520. For example, a bundle of strokes merged by machine learning may be regarded as a unit that may be grouped into one character. Here, the extraction of the feature information about the bundled strokes may mean extracting the feature information from the divided blocks so as to be grouped into characters. For example, the feature extraction and handwriting recognition module 530 may perform handwriting recognition corresponding to a minimum unit of character candidates using the feature information based on a handwriting learning database (not shown).

The recognition result output module 540 may output the recognized final result among the character candidates.

According to various embodiments, it is possible to provide a fast handwriting recognition speed and enhanced recognition result through machine learning-based learning for merging or separating consecutive strokes corresponding to the handwriting input even when the user's handwriting is severely overwritten.

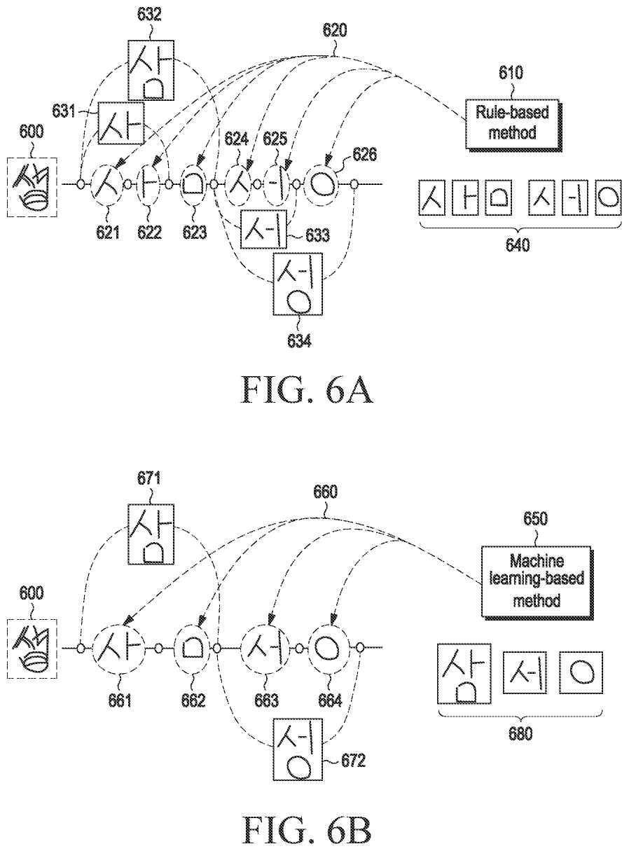

FIGS. 6A and 6B are views illustrating a comparison between a rule-based method and a machine learning-based method according to various embodiments.

FIG. 6A illustrates stroke merging through a rule-based method for a handwriting input corresponding to overwriting, and FIG. 6B illustrates machine learning-based stroke merging.

For example, referring to FIG. 6A, when a rule-based method 610 (or a rule-based algorithm) is applied by pre-processing strokes corresponding to the overwritten handwriting input 600, a plurality of paths 620 may be extracted for the strokes. As illustrated in FIG. 6(a), in the rule-based method 610, as the number of divided strokes 621, 622, 623, 624, 625, and 626 increases, the number of paths 620 may also increase. Further, the number of inputs to the handwriting recognition engine may also increase, so that an error in the final path result may increase in calculating the optimal candidate 640 among the many candidate characters 631, 632, 633, and 634 in relation to the divided strokes 621, 622, 623, 624, 625, and 626.

On the other hand, referring to FIG. 6(b), according to various embodiments, when the strokes corresponding to the overwritten handwriting input 600 are pre-processed, and the machine learning-based method 650 (or a machine learning algorithm) is applied, the number of paths 660 possible in relation to the merged or separated strokes 661, 662, 663, and 664 is also reduced, and thus an optimal candidate 680 may be calculated among the candidate characters 671 and 672.

As illustrated in FIG. 6B, according to various embodiments, when the machine learning-based method 650 is used, strokes groupable into one character may be merged or separated through inference, and a stable recognition result may be output. It is also possible to reduce the number of invocations of the handwriting recognition engine by merging strokes, thereby enhancing the handwriting recognition speed.

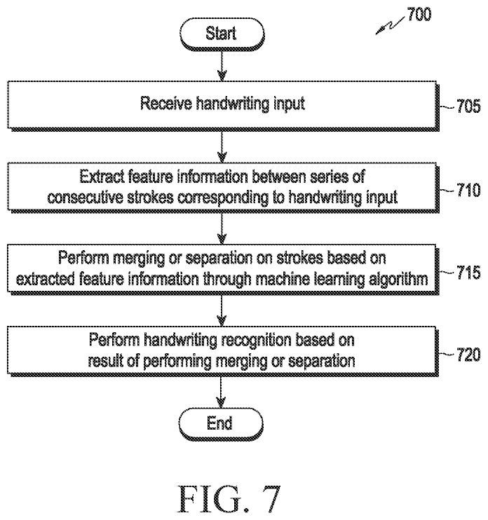

FIG. 7 is a flowchart 700 illustrating operations of an electronic device according to various embodiments.

Referring to FIG. 7, the operation method may include operations 705 to 720. Each step/operation of the operation method of FIG. 7 may be performed by at least one of an electronic device (e.g., the electronic device 101 of FIG. 1 or the electronic device 101 of FIG. 3) or at least one processor (e.g., at least one of the processor 120 of FIG. 1 or the processor 320 of FIG. 3) of the electronic device. According to an embodiment, at least one of operations 705 to 720 may be omitted, some operations thereof may be performed in reverse order, or other operations may be added thereto.

Referring to FIG. 7, in operation 705, the electronic device 101 may receive a handwriting input. According to an embodiment, the user's handwriting input may be received through the display of the electronic device 101, and the handwriting input may be displayed on a first portion (e.g., an input window) of the display 360.

In operation 710, the electronic device 101 may extract feature information between a series of consecutive strokes corresponding to the handwriting input.

According to an embodiment, the electronic device 101 may perform pre-processing on the received handwriting input and extract feature information between a series of consecutive strokes corresponding to the pre-processed handwriting input.

According to an embodiment, the electronic device 101 may extract feature information between a predesignated number of strokes among the series of consecutive strokes. For example, the electronic device 101 may extract features between strokes, every two consecutive strokes. According to an embodiment, the feature information between the strokes may include at least one of a straightness of stroke, a slope angle of stroke, position information about a start point of stroke, a slope angle of a virtual ligature, or a length ratio of the virtual ligature.

In operation 715, the electronic device 101 may perform merging or separation on the strokes based on the extracted feature information through a machine learning algorithm related to character separation. According to an embodiment, the machine learning algorithm related to the character separation may be trained to perform the character separation on overwritten characters or characters of a normal sentence. According to an embodiment, the machine learning algorithm related to the character separation may be trained using samples of overwritten characters and normal sentence samples to perform character separation on overwritten characters or characters written in normal sentences.

According to an embodiment, training on the machine learning algorithm may be performed using at least one of a multi-layer-perceptron (MLP), a support vector machine (SVM), or deep learning.

According to an embodiment, training of the machine learning algorithm may be performed based on a 2-class supervised learning method that extracts a numerical value indicating merging on a stroke with a likelihood of the same character and extracts a numerical value indicating separation on a stroke with a likelihood of different characters.

In operation 720, the electronic device 101 may perform handwriting recognition based on the result of performing the merging or separation. According to an embodiment, the electronic device 101 may display a handwriting recognition result corresponding to the handwriting input on the display based on a result of performing the merging or separation through a handwriting recognition engine. According to an embodiment, the electronic device 101 may display the user's handwriting input on a first portion (e.g., input window) of the display 360, and convert the handwriting recognition result corresponding to the handwriting input into text and display the text on a second portion (e.g., output window) of the display 360.

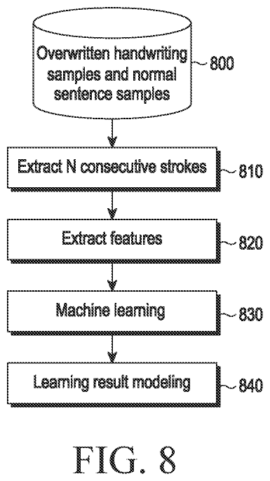

FIG. 8 is a view illustrating a machine learning process according to various embodiments.

According to various embodiments, a method for training a machine learning algorithm may include the step 800 of preparing an overwritten handwriting sample and a normal sentence sample as shown in FIG. 8, the step 810 of extracting N consecutive strokes, the step 820 of extracting features between the strokes, the step 830 of applying machine learning, and the step 840 of modeling a learned result.

In step 800 of preparing the overwritten handwriting sample and the normal sentence sample, the handwriting samples may include a plurality of writing samples. According to an embodiment, stroke merging and separation may be performed to group or separate overwritten handwriting or handwriting in a normal sentence to correspond to a character and, to train machine learning for stroke merging and separation, information about what character the strokes correspond to, as well as overwritten samples and normal sentence samples, may be required. For example, if the Korean characters ‘ [symbol] ’ are handwritten on the electronic device 101, handwriting data for the characters ‘ [symbol] ’ in various sizes and shapes, as well as handwriting samples for ‘ [symbol] ’ overwritten to output ‘life’ in text may be prepared. Further, for the handwriting sample for ‘ [symbol] ’ overwritten in one character area, character separation information about the character ‘ [symbol] ’ and the character ‘ [symbol] ’ all may be included in the handwriting sample.

Further, for handwriting recognition to be possible for various characters as well as the characters ‘ [symbol] ’ the handwriting samples related thereto all may be stored in the handwriting sample database.

As such, a machine learning model may be generated using a plurality of handwriting samples as training data including the character separation information related to the handwriting samples. Here, the machine learning model may be an algorithm trained using handwriting samples, and may be trained based on, e.g., a 2-class supervised learning method.

The step 810 of extracting N consecutive strokes may be a step of extracting a predesignated number of strokes among a series of consecutive strokes, every handwriting sample stored in the handwriting sample database. For example, two or more strokes may be extracted for feature extraction.

The step 820 of extracting features between strokes may include a step of extracting feature information between a predesignated number of strokes for character merging and separation. For example, the feature information between the strokes may include at least one of a straightness of stroke, a slope angle, position information about a start point of stroke, a slope angle of a virtual ligature, or a length ratio of the virtual ligature, but not be limited thereto.

The step 830 of applying machine learning may include a step of applying machine learning based on the feature information extracted for all handwriting samples stored in the handwriting sample database.

The step 840 of modeling the learned result is modeling the relationship between the handwriting sample and the character separation information, and the learned result may be applied when merging or separating a series of consecutive strokes corresponding to the handwriting input actually made by the user.

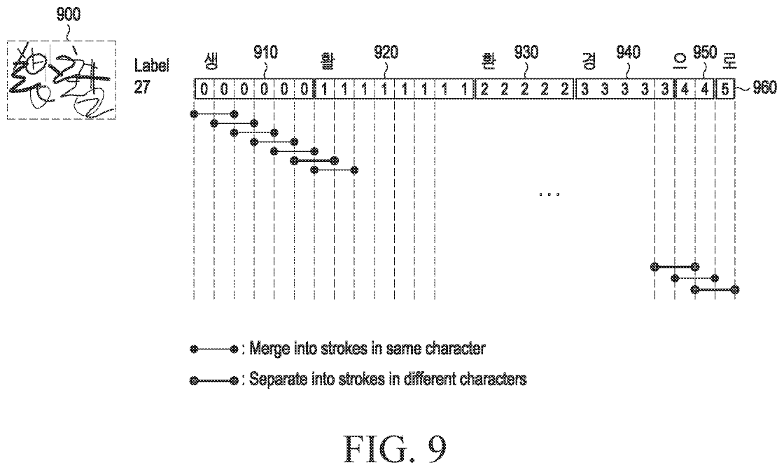

FIG. 9 is a view illustrating an example of an operation of merging or separating consecutive strokes according to various embodiments.

Referring to FIG. 9, ‘ [symbol] ’ 900, as overwritten characters, is described as an example below. In the six characters, it may be identified that the first character ‘ [symbol] ’ 910 is composed of six strokes, and information about the character ‘ [symbol] ’ 910 is created as “0, 0, 0, 0, 0, 0”. Likewise, the character ‘ [symbol] ’ 920 is composed of a total of eight strokes, and information corresponding thereto may be composed of “1, 1, 1, 1, 1, 1, 1, 1”. The character ‘ [symbol] ’ 930 is composed of a total of five strokes, and information corresponding thereto may be composed of “2, 2, 2, 2, 2”. Further, the character ‘ [symbol] ’ 940 is also composed of a total of five strokes, and information corresponding thereto may be composed of “3, 3, 3, 3, 3”. The character ‘ [symbol] ’ 950 is composed of a total of two strokes, and information corresponding thereto may be composed of “4, 4”. The character ‘ [symbol] ’ 960 is composed of a total of two strokes, and information corresponding thereto may be composed of “5”. In relation to the overwritten characters ‘ [symbol] ’ 900, all strokes may be represented as indexes.

FIG. 9 illustrates feature extraction for a predetermined number (e.g., two) of strokes among a series of consecutive strokes. For example, if the two extracted strokes are extracted from the same character, it may be processed as merged, and if extracted from different characters, it may be processed as separated. Accordingly, since the last stroke of the character ‘ [symbol] ’ and the first stroke of the character ‘ [symbol] ’ have different index values, they may be separated.

According to various embodiments, it is possible to expand learning samples by generating samples overwritten variously such as a one-character area, two-character area, or three-character area. To that end, a method for generating each character to fit the corresponding area may be introduced (or provided). Further, such a configuration may be made so that normal sentences may be recognized even in the overwrite mode by generating learning samples even for normal sentence samples.

According to various embodiments as shown in FIG. 9, the strokes that may be grouped into one character may be pre-merged through machine learning.

Further, according to various embodiments, it is possible to recognize handwriting regardless of the number of character areas, the number of overlapping characters in the corresponding character area, and the degree of overlapping because it is identified whether merging or separation is possible every N ones among a series of consecutive strokes although the characters are overwritten in two or more character areas as well as the characters overwritten in one character area.

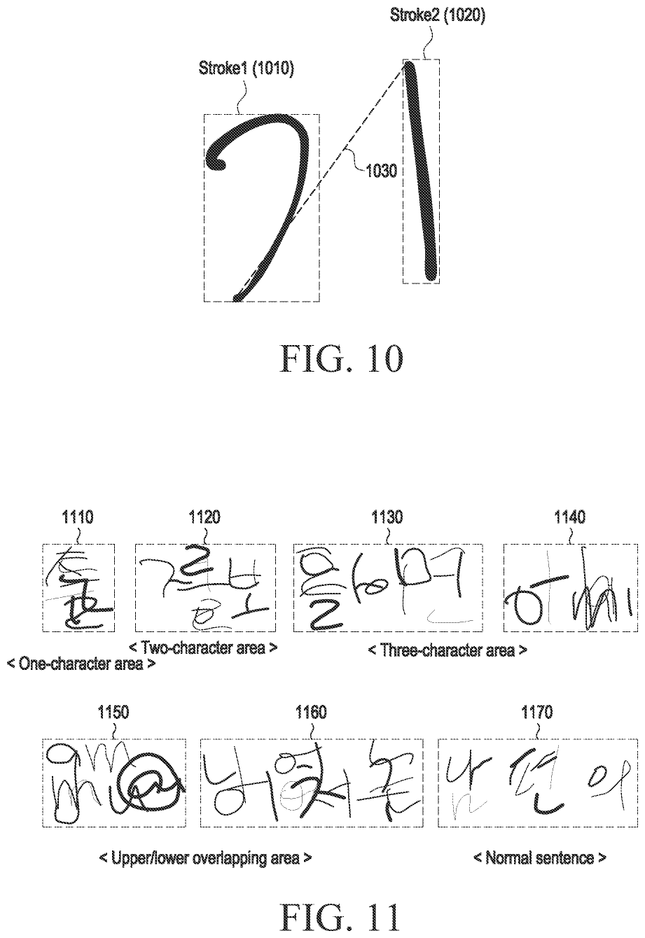

FIG. 10 is a view illustrating an example of stroke-related feature extraction according to various embodiments.

Referring to FIG. 10, the electronic device 101 may extract features of two strokes constituting a handwriting input (e.g., the character ‘ [symbol] ’). For example, the straightness and slope angle (or inclination) may be identified using the first point and the last point of each of the two strokes 1010 and 1020 (e.g., ‘ [symbol] ’ and ‘ [symbol] ’) constituting the handwriting input. Further, the electronic device 101 may identify position information about each stroke 1010 and 1020. For example, the electronic device 101 may identify position information about each stroke 1010 and 1020 based on the first and last points of each stroke 1010 and 1020. Also, a feature of an empty space stroke (e.g., a virtual stroke (ligature)) 1030 between the last point of stroke 1 1010 and stroke 2 1020 may be extracted.

According to various embodiments, the electronic device 101 may merge strokes (e.g., the character ‘ [symbol] ’) that may be the same character, using feature information about a series of consecutive strokes (e.g., “ [symbol] ” and “ [symbol] ”). For example, although FIG. 10 exemplifies a case where features between strokes are extracted every two consecutive strokes among a series of consecutive strokes, the disclosure is not limited thereto. For example, features between three consecutive strokes may be extracted, and the predetermined number for the strokes used to extract features among the series of consecutive strokes corresponding to the handwriting input may be set by the manufacturer of the electronic device 101. For example, as the predetermined number for the strokes used to extract features increases, more feature information about strokes may be obtained, making more accurate recognition possible. As the predetermined number for the strokes used to extract features decreases, feature information may be obtained faster, so that recognition speed may increase. Thus, the predetermined number for the strokes used to extract features is adjustable as needed.

FIG. 11 is a view illustrating an example of a learning sample for various letter areas according to various embodiments.

According to various embodiments as shown in FIG. 11, when the electronic device 101 applies a machine learning algorithm to handwriting input, it is possible to obtain an accurate recognition result when applying the machine learning algorithm even to a non-overwritten handwriting input as in the normal sentence 1170; this is accomplished by learning samples for handwriting inputs of various overwritten handwriting regardless of the degree of overlapping in the corresponding character area and the number of character areas as in the one-character area 1110, two-character area 1120, three-character areas 1130 and 1140, and upper/lower overlapping areas 1150 and 1160.

For example, the one-character area 1110 represents a case where characters corresponding to one character are input overlapping each other, and the two-character area 1120 represents a case where characters corresponding to two characters are input overlapping each other. According to various embodiments, when a plurality of (e.g., four) characters corresponding to two characters are input in the two-character area 1120 while overlapping each other, the handwriting recognition result corresponding to the four consecutive characters may be output.

It may be possible to perform character separation on all characters written regardless of whether the characters are overwritten characters or normal sentence characters by performing learning using learning samples corresponding to the characters overwritten or written in normal sentences in various manners as shown in FIG. 11.

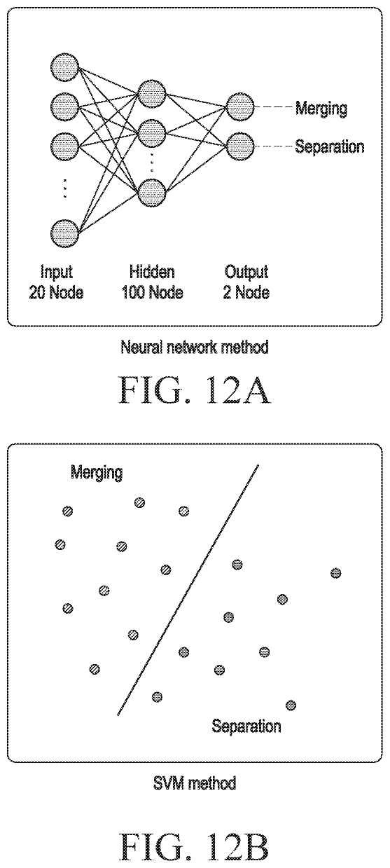

Meanwhile, it may be identified from comparison in recognition rate when merging strokes between using the rule-based method and using the machine learning-based method that the handwriting recognition rate and recognition speed in overwriting may be higher in the machine learning-based method than the rule-based method. For example, the machine learning-based method may enhance the recognition rate by about 1 to 2% and the recognition speed by 20 to 30% over the rule-based method. FIGS. 12A and 12B are views illustrating examples of a machine learning algorithm according to various embodiments.

FIG. 12A illustrates an example of a machine learning algorithm in which strokes are merged or separated using a neural network method, and FIG. 12B illustrates another example of a machine learning algorithm in which strokes are merged or separated using a support vector machine (SVM) method.

The neural network method of FIG. 12A illustrates a process of finding an optimal merged stroke or separated stroke through merging or separation for each step while proceeding step by step from left to right on each node, for example. In contrast, the SVM method of FIG. 12B illustrates a process of merging or separating strokes through clustering.

Although two machine learning algorithms are illustrated in FIGS. 12A and 12B, other various machine learning algorithms may be used, and the so-trained machine learning algorithm may be stored in a memory (e.g., the memory 330 of FIG. 3).

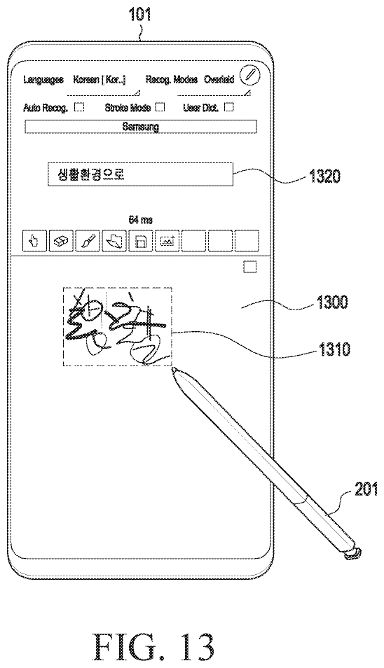

FIG. 13 is a view illustrating an example handwriting input screen in an electronic device according to various embodiments.

FIG. 13 illustrates a screen 1300 according to execution of an application related to a handwriting input in the electronic device 101. As illustrated in FIG. 13, if the application is executed, an input window for handwriting input may be displayed, and the user may input handwriting 1310 through the handwriting input window using the stylus pen 201. For example, when the user inputs characters by overwriting, the characters corresponding to the number of two or more character areas may be input while overlapping each other, as illustrated in FIG. 13. According to an embodiment, when the machine learning-based method is used before the handwriting recognition engine is used, the electronic device 101 may display the handwriting recognition result 1320 regardless of, e.g., the number (or the size of the character area) of character areas in handwriting input 1310, the number of overlapping characters in the corresponding character area, and the degree of overlapping, corresponding to the overwritten characters.

According to various embodiments, the characters overwritten by the user are ones written in a sequential order. Thus, even for overwritten characters, handwriting recognition is performed on strokes grouped after merging or separating strokes to group them into one word through the machine learning-based method. Therefore, the electronic device may display the handwriting recognition result 1320 quickly in real-time in response to the handwriting input.

Meanwhile, FIG. 13 illustrates an example in which only the final handwriting recognition result 1320 is displayed in response to overwritten handwriting input 1310. However, in another possible implementation, character candidates corresponding to the handwriting input may be together displayed during the handwriting input 1310 and, if the handwriting input 1310 is complete, the final handwriting recognition result 1320 may be displayed.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

According to various embodiments, in a storage medium storing instructions, the instructions configured to be executed by at least one processor to enable the at least one processor to perform at least one operation, the at least one operation may comprise receiving a handwriting input through a display of an electronic device, extracting feature information between a series of consecutive strokes corresponding to the handwriting input, performing merging or separation on the strokes based on the extracted feature information through a machine learning algorithm related to character separation, and perform handwriting recognition based on a result of the merging or separation.

The embodiments herein are provided merely for better understanding of the present invention, and the present invention should not be limited thereto or thereby. It should be appreciated by one of ordinary skill in the art that various changes in form or detail may be made to the embodiments without departing from the scope of the present disclosure defined by the following claims.

What is claimed is:

1. An electronic device, comprising:
a display;
at least one processor; and
memory storing instructions configured to, when executed, enable the electronic device to:
receive a handwriting input including overwritten characters through the display;
extract feature information from the handwriting input;
merge or separate a series of consecutive strokes of the handwriting input based on the feature information; and
perform handwriting recognition based on a result of performing the merging or the separating.

2. The electronic device of claim 1, wherein the instructions are configured to enable the electronic device to extract the feature information between a predesignated number of strokes among the series of consecutive strokes.

3. The electronic device of claim 1, wherein the feature information between the series of consecutive strokes includes at least one of a straightness of stroke, a slope angle, position information about a start point of stroke, a slope angle of a virtual ligature, or a length ratio of the virtual ligature.

4. The electronic device of claim 1, wherein the instructions are configured to enable the electronic device to merge or separate the series of consecutive strokes of the handwriting input based on the feature information, using a machine learning algorithm related to character separation,
the machine learning algorithm is trained using overwritten character samples and normal sentence samples to perform the character separation on overwritten characters or characters of a normal sentence.

5. The electronic device of claim 4, wherein the instructions are configured to enable the electronic device to use at least one of a multi-layer-perceptron (MLP), a support vector machine (SVM), or deep learning for training the machine learning algorithm.

6. The electronic device of claim 1, wherein the instructions are configured to enable the electronic device to display a handwriting recognition result corresponding to the handwriting input on the display based on the result of performing the merging or the separation through a handwriting recognition engine.

7. The electronic device of claim 1, wherein the instructions are configured to enable the electronic device to:
display the handwriting input on a first portion of the display;
convert a handwriting recognition result corresponding to the handwriting input into text; and
display the text on a second portion of the display.

8. The electronic device of claim 1, wherein the instructions are configured to enable the electronic device to:
perform pre-processing on the handwriting input received; and
extract the feature information between the series of consecutive strokes corresponding to the handwriting input that is pre-processed.

9. The electronic device of claim 1, wherein the instructions are configured to enable the electronic device to train the machine learning algorithm related to the character separation based on a 2-class supervised learning method that extracts a first numerical value indicating merging on a stroke with a likelihood of the same character and extracts a second numerical value indicating the separation on the stroke with a likelihood of different characters.

10. A method for processing a handwriting input based on learning in an electronic device, the method comprising:
receiving the handwriting input including overwritten characters through a display of the electronic device;
extracting feature information from the handwriting input;
merging or separating a series of consecutive strokes of the handwriting input based on the feature information; and
performing handwriting recognition based on a result of performing the merging or the separating.

11. The method of claim 10, wherein extracting the feature information between the series of consecutive strokes includes extracting first feature information between a predesignated number of strokes among the series of consecutive strokes.

12. The method of claim 10, wherein the feature information between the series of consecutive strokes includes at least one of a straightness of stroke, a slope angle, position information about a start point of stroke, a slope angle of a virtual ligature, or a length ratio of the virtual ligature.

13. The method of claim 10, wherein the merging or the separating comprising the merging or the separating the series of consecutive strokes of the handwriting input based on the feature information, using a machine learning algorithm related to character separation,
the machine learning algorithm is trained to perform the character separation on overwritten characters or characters of a normal sentence.

14. The method of claim 13, further comprising performing training on the machine learning algorithm using at least one of a multi-layer-perceptron (MLP), a support vector machine (SVM), or deep learning.

15. A storage medium storing instructions, the instructions configured to be executed by at least one processor to enable an electronic device comprising the at least one processor to perform at least one operation, the at least one operation comprising:
receiving the handwriting input including overwritten characters through a display of the electronic device;
extracting feature information from the handwriting input;
merging or separating a series of consecutive strokes of the handwriting input based on the feature information; and
performing handwriting recognition based on a result of performing the merging or the separating.

16. The electronic device of claim 1, wherein the instructions are configured to enable the electronic device to identify straightness and slope angle using a first point and a last point of each of the strokes constituting the handwriting input and extract the feature information including the straightness and the slope angle.

17. The electronic device of claim 1, wherein the instructions are configured to enable the electronic device to identify position information about a start point of each stroke based on a first and a last points of each stroke and extract the feature information including the position information.

18. The electronic device of claim 1, wherein the instructions are configured to enable the electronic device to identify a feature of a virtual ligature between a last point of strokes and extract the feature information including position information about each stroke based on a first and last points of each stroke and extract the feature information including a slope angle of the virtual ligature and a length ratio of the virtual ligature.
